(19) United States
(12) Patent Application Publication
(10) Pub. No.: US 2005/0217098 A1
(43) Pub. Date: Oct. 6, 2005

(54) Device and process for producing rolled sections

(76) Inventors: Alexander Egidi, Parkstetten (DE); Karl-Heinz Fueller, Neu-Ulm (DE)

Correspondence Address: PENDORF & CUTLIFF, 5111 MEMORIAL HIGHWAY, TAMPA, FL, 33634-7356, US

(21) Appl. No.: 11/095,476

(22) Filed: Mar. 31, 2005

(30) Foreign Application Priority Data
Mar. 31, 2004 (DE) 10 2004 016 524.6

(51) Int. Cl. B21B 13/10; B23P 11/00

(52) U.S. Cl. 29/430; 29/431; 29/458

(57) ABSTRACT

The task of the invention is to provide an economically optimized flexible device for production of simple to complicated rolled sections, as well as an economically optimized process for production of simple to complicated rolled profiles. This task is solved by a process and a device for production of rolled sections, in that first a deforming of the blank into a rolled section occurs, and a joining of the blank and/or the rolled section with at least one other component occurs, wherein a production of the at least one component occurs in at least one production facility coordinated in space and time to the other process steps. The invention is particularly adapted for commercial and passenger vehicles.

### BACKGROUND OF THE INVENTION

1. Field of the Invention

The invention concerns a device for producing rolled sections according to the precharacterizing portion of Patent claim 1 and a process for production of rolled sections according to the precharacterizing portion of Patent claim 5.

2. Related Art of the Invention

Rolled sections are well known in which a blank obtained from a roll is deformed by a continuous process into a rolled section having a continuous U-shaped rolled profile cross section using roller profiling. This type of rolled section has a high torque resistance against torque and bending. This is advantageous when used in vehicles, since high impact energies must be absorbed following collision with other vehicles or with objects. In addition, materials having a high stiffness are employed for these rolled sections, so that local kinking is avoided. For safety reasons, such rolled sections, which are frequently used in the automobile industry, for example, as A-, B-, C-, and D-columns, are required to satisfy stringent requirements. Such rolled sections, however, do not meet the increasing requirements of the automobile industry with regard to the complexity of the geometry of the roller profiled cross sections.

In particular after carrying out some of the production operations such as, for example, deforming of a blank into a rolled section and joining the blank with a further component, these rolled sections are stacked as a rule and are only later further processed separately at another point in time. Transportation and logistical costs resulting therefrom limit the cost effectiveness of this production process for rolled sections.

WO 03 000 440 A1 discloses a device and a process for joining of blanks and rolled sections over their total rolled section length. The device is comprised of two unrolling stations, two production facilities for deforming in which the blank is roller profiled, two production facilities for joining, in particular welding, wherein the production facilities are provided in the device as a production line. This has the consequence, that joining is to be carried out in this device after the first process step of roller profiling, substantially limiting the flexibility of the device. Such devices for production of rolled sections have demonstrated themselves to be unsuited for the joining of multiple supplemental components for reinforcement of certain sections of the rolled segment, a so-called partial joining.

A process for production of rolled sections is known from document DE 195 45 525 A1. In this process, the production of rolled sections occurs in a single device, a so-called production line, with immediate sequential processing steps. A device of this type for production of rolled sections has been found to be unsuitable for the partial joining of multiple supplemental components to the rolled section, since the joining must occur over the entire length of the rolled section. Further, the individual processing facilities in the production line are relatively rigidly coupled to each other, so that the flexibility of the device is substantially limited.

### SUMMARY OF THE INVENTION

Beginning with this as the state of the art, it is the task of the present invention to conceive of an economically efficient optimized flexible device for production of simple to complicated rolled sections, as well as an economically optimized process for production for simple to complicated roller sections.

With regard to the inventive device of the type having the characteristics of the precharacterizing portion of Patent Claim 1, this task is solved by the characterizing features of Claim 1, and with regard to the process of the type having the characteristics of the precharacterizing portion of Patent Claim 5, this is solved by the characterizing features of Claim 5. Further advantageous embodiments and further developments of the invention can be seen from the dependent claims and the accompanying description.

The inventive solution is provided by a device for production of rolled sections with at least:
a production facility for deforming a blank into a rolled section,
a production facility for joining the blank and/or rolled section with at least one further complementary component, wherein at least one production facility for production of the at least one component is designed to be coordinated with the other production facility.

One advantage of the inventive device for production of rolled sections is comprised therein, that all processed steps can be carried out on a single device, whereby this leads to an increase of output (product yield increase) and to a savings in time. A high unit output over time results in high economic efficiency of the inventive device for production of rolled sections. Therein, in the device for production of rolled sections, the production facility for deforming a blank into a rolled section can be conventional or however also be a flexible roller profiling device according to DE 100 11 755 A1.

The subject matter of the invention provides the substantial advantage, that simple to complicated rolled sections can be produced in the single device wherein other components, in particular reinforcements such as supplemental rolled profiles, however also screws, nuts, rivets, are joined together with the rolled sections in-line (in a production line) and/or on-line (in direction connection with the production line). The in-line, or as the case may be, on-line joining of the rolled section makes possible a positionally precise production of the simple to complicated rolled section. The on-line production increases the flexibility of the device, since the production facility for production of at least one component can be provided before as well as after the production facility for joining. This mobile arrangement of the production facility for production of at least one component enables a conformance of this production facility to the further production facilities, in particular the production facility for joining and the production facility for deforming. The coordinating or synchronizing of the production facilities can be discontinuous, in the sense of a discontinuous operation, a so-called asynchronous control or hook-up, or continuous in the sense of a continuous operation, a so-called synchronized control or hook-up. Thereby, a supply of components is delivered as necessary from the device for production of at least one component to the other production facilities. As a result, there is no longer the need to transport the rolled sections, for example to a separate production facility or a deformation line. The conventional logistical problem, which is associated with conventional devices for production of rolled sections, is solved in accordance with the present invention.

A further advantage of the inventive device is comprised therein, that in this device any number of production facilities can be coordinated to each other and can be connected or interlaced sequentially. Thereby, the need for human intervention is reduced, and the economy of the device is increased.

In a preferred embodiment of the inventive device, at least the one production facility for joining is provided to be moveable, preferably prior to the production device for deforming.

One advantage of this embodiment is comprised therein, that the production device for joining can be provided flexibly on the production device for production of rolled sections. This makes possible a joining in the sense of releasable and not releasable joining or marrying of the rolled section with other components according to the requirements of the structure of assembled parts. Therein, the production device for joining is preferably located ahead of the production device for deforming, in order to join particular components with the blank, such as for example rolled sections as reinforcing elements. Further, the production facility for deforming can include a production facility for roller profiling and/or a production facility for drawing and/or pressure deforming, in particular deep drawing. This embodiment of the invention has been found to be particularly advantageous in closed rolled profile cross sections.

A further advantage of this embodiment is comprised therein, that rolled profiles with strongly divergent rolled profile cross sections can be joined together in the production facility into an assembly of parts.

It is further possible, that the production facility for joining is located immediately after the production facility for deforming of the blank into a rolled shape in such a manner, that at least one component is joined with the rolled section to form an assembly of parts.

In a further advantageous embodiment of the inventive device, the device for production of rolled sections supplementally includes at least one interconnected production facility for straightening, and/or an interconnected production facility for cutting or trimming, and/or an interconnected production facility for marking, and/or an interconnected production facility for deep drawing, and/or an interconnected production facility for crimping, and/or an interconnected production facility for bending, and/or an interconnected production facility for separating, and/or a production facility for imparting holes, and/or an interconnected production facility for washing, and/or an interconnected production facility for coating and/or an interconnected production facility for thermal treating and/or at least one interconnected spiral storage.

Since the blank is first straightened, cut, deformed in a spiral storage interconnected in the sense that it is connected to other production facilities, and thereafter is marked, before it then is supplied to a roller profiling process and subsequently deformed by a deformation process and in particular thereafter is again able to be roller profiled, it is accomplished, that by means of the roller profiling, preferably with the integrated deforming, deep drawing, and/or crimping, a rolled section with a rolled profile cross section changing along its longitudinal extent can be produced. After the rolling profiling process, the rolled section is deformed by pressure or drawing, in particular deep drawing, and/or stretch drawing, and/or stamping and/or crimping. In the production facility for crimping, which is interconnected in the sense of being coordinated with another production facility, which can be provided following the production facility for deforming, in particular roller profiling, or preferably between two processing facilities for deforming, in particular roller profiling, the stiffness of the rolled section is increased by crimping or by creasing. In an interconnected processing facility for bending, the rolled section is bent. In order to ensure the desired length of the rolled section, the rolled section after bending is cut or separated in an interconnected processing facility for separating. Subsequently, holes are imparted to the rolled section with a high precision in an interconnected processing facility for imparting holes, in order to achieve improved build-out utility. Subsequently, the rolled section runs through a processing facility for washing and coating, preferably KTL, in order to prepare it for a possible following further processing.

In this advantageous embodiment of the invention, the production of the rolled-section, and in certain cases, the production of a modified rolled profile cross section, occurs in a single production process, particularly in timesaving manner and also without intermediate storage and therewith the associated logistical costs.

A substantial advantage of the inventive device is comprised therein, that the sequential process steps can be carried out in a compact device with individual interconnected processing facilities, which has been found to be particularly economical.

In another advantageous embodiment of the invention, the processing facility for production of at least one component is arranged in such a manner relative to the processing device for deforming a blank that the supply of the components can be operated discontinuously.

The advantage of this embodiment of the inventive process is comprised therein, that it can be designed with flexibility. It is possible to select the location for the delivery of the components depending on the rolled profile cross section requirements and therewith the supply of the components occur localized and coordinated, in particular discontinuously, with the other processing facilities.

A further object of the present invention concerns a process for production of rolled sections with the process steps:
deforming a blank to a rolled section,
joining the blank and/or rolled section with at least one other component,
   wherein the production of the at least one other component occurs in at least one other processing facility coordinated in space and time to the other processing steps.

A substantial advantage of the inventive process is comprised therein, that an increase in the production output, and a saving in time, is made possible both in the production of simple as well as complicated rolled section, since all process steps occur in a single device and therewith rolled sections can be produced with increased precision. These processes have demonstrated themselves to be very economical.

The advantage of the subject of the invention is comprised therein, that due to the spatial and time coordinated production of at least one component in at least one processing facility and the joining in the sense of marrying, welding of blanks and/or rolled sections to a structure of assembled components, the transport costs and the logistical costs are significantly reduced. By the joining together in a processing facility for joining of blanks and/or rolled sections, coordinated with another processing facility, into a structure of assembled components, there can supplementally be satisfied high precision and tolerance requirements of the assembled structure of components. This is made possible by a reduction of the possibilities of defects and a more exact positioning of the blank and/or rolled section relative to each other. As a result, there occurs the joining of blank and/or rolled section to a structure of assembled parts in a single device for production of rolled sections, in contrast to the state of the art known devices, in which a stack of rolled sections are further processed later and separately at another point in time.

In an advantageous embodiment of the inventive process, at least one component is joined with at least one blank in a processing facility prior to the processing facility for deforming of the blank into a rolled section.

One advantage of this embodiment is comprised in the flexible joining of components with the blank and/or rolled section. This joining is carried out as a simple joining and makes possible the satisfaction of the requirements of the structure of assembled parts. Therein, the joining preferably occurs prior the production facility for deforming, in order to join with the blank additional rolled sections as reinforcement elements, and/or screws, and/or nuts, and/or rivets. The deforming can subsequently be carried out as roller profiling, and/or as draw and/or pressure deforming, in particular deep drawing. Preferably, this embodiment of the process is employed in the case of a closed rolled profile cross section. It is also possible to apply this embodiment of the invention with open rolled profile cross sections.

A further advantage of this embodiment is exhibited therein, that rolled sections with strongly divergent rolled profile cross sections can be joined together to a structure of assembled components.

In a further advantageous embodiment of the invention, during the deforming in the process for production of rolled sections, and/or immediately subsequent to the processing facility for deforming a blank into a rolled section, at least one component, which is produced in at least one separate located processing facility, is joined into a structure of assembled components discontinuously using a production facility for joining with the rolled section.

The advantage of the discontinuous joining during deforming is comprised therein, that for example a complicated joining of components to the side walls, in particular to the inner side walls of the rolled sections, in contrast to a simple joining, can occur following one deforming step and prior to a further deforming step. Therein, the discontinuous joining makes possible by means of asynchronous coordination of the production facility for joining with at least one other production facility, in particular with the production facility for deforming and/or with the production facility for production of at least one component, a production facility of complicated rolled profile cross sections, in which at a predetermined point in time at least one further component is provided, and this is joined together with the rolled section.

A further advantage of the discontinuous joining during the deformation is comprised therein, that the joining can be carried out in essentially those areas of the rolled section, which in the following processing operations can no longer be joined in the processing facility for joining and/or which, due to subsequent production processes, do not allow joining. As a rule, in complicated rolled sections, the areas which are suited for joining of further components are limited.

The advantage of the discontinuous joining immediately following the processing facility for deforming and/or immediately subsequent to the interconnected processing facility, in particular subsequent to the production facility for separating and/or the production facility for imparting holes and/or the production facility for crimping, is, that the rolled section after passing through the intended production operations exhibit the end contour necessary for the joining and no subsequent production operations can damage the joined structure of assembled components. Further, the joined components can exhibit complicated geometries, since they can be joined for example on the outer sidewalls of the rolled section.

The advantage of the discontinuous joining during deforming in the device for production of rolled sections and immediately subsequent to the deformation of the rolled section is comprised therein, that an improved positional accuracy of the components and/or the rolled sections can be ensured, so that positioning on a new production facility is not required.

Further, it is possible to carry out the joining with interruption subsequent to the production facility for deforming the blank into a rolled section, in order to carry out quality control of the structure of assembled components.

Alternatively, or additionally thereto, it is also conceivable to carry out the joining with delay after the inventive device for production of rolled sections, in order to carry out quality control of the structure of assembled components.

In a further advantageous embodiment of the inventive process, the blank is deformed in the production facility for deforming a blank into a rolled section in two steps separated from each other.

Therein it is advantageous that complex cross sectional changes can be introduced in the desired rolled section area for a constant profile cross section, wherein the wall strength of the rolled section remains almost unchanged. The inventive process demonstrates itself particularly advantageous in that the blank, after the first roller profiling and prior to the further roller profiling, can be deep drawn and/or stretched and/or crimped, without negatively impacting or detracting from the mechanical characteristics of the deformed blank. Therewith, the inventive process ensures a deforming into complex, particularly rigid rolled sections.

An embodiment of this type of inventive process has the further advantage, that the rolled sections processed by means of the roller profiling in two steps with a deep drawing, and/or stretching, and/or crimping are deformed not in a single step, but rather stepwise, in order to produce an advantageous deformed joining condition over the rolled profile cross section. Therewith, it is achieved that, by means of the roller profiling in two separate steps, a rolled profile with a rolled profile cross section changing over its longitudinal extent can be produced, which can be adapted to a later intended use. The production of the changing rolled profile cross section occurs with savings in time and without the conventional intermediate storage and the therewith associated logistical expenditure.

Alternative to this embodiment of the inventive process, the roller profiling can occur conventionally in one step. This roller profiling makes it possible, by means of a simple roller profiling, to produce rolled sections which exhibit a simple rolled profile cross section.

According to a further embodiment of the inventive process, as starting material for the blank, high strength steels, and/or deep drawn steels, and/or titanium alloys, and/or light weight construction steels, and/or metal containing composite materials are employed.

One advantage of the inventive process is in the possibility of employment of high and/or higher strength steels as starting materials for the blank, which is roller profiled, hereinafter deformed by deep drawing to a rolled section with variable cross section, and subsequently further roller profiled. Besides a reduction in weight, these materials have the advantage, that less installation space is needed, and on the other hand, the increasing safety requirements in motor vehicle construction, specifically in the area of structure and safety components, can be satisfied.

A substantial advantage of the inventive process is the ability to produce structures of assembled components of material which can only be deformed with difficulty using conventional deep drawing. In particular, high strength steels (so called light weight construction steels), preferably from the group of the multi-faced steels, such as for example dual phase steels (DP-steels), complex phase steels (CP-steels), martensitic phase steels (MS-W-steels), or residual austentite steels (transformation induced plasticity TRIP-steel), which can be deformed only with difficulty with conventional deep drawing, are ideally suited for the production of rolled shaped using roller profiling with integrated deep drawing. These steels have particularly suited rigidity characteristics with regard to the deformability-rigidity behavior. The very high rigidity of these steels at high starting rigidity is particularly advantageous for the crash behavior. Therewith, the inventive process allows an increase in the rigidity in desired construction areas also by the selection of a suited material, without requiring for example an expensive thermal treatment. Therein, high strength steels offer potential cost savings, since due to the increased stability, less material can be employed to provide the same shape stability.

Alternatively, or in addition thereto, in accordance with the invention, deep drawn steels, titanium alloys, or nickel alloys, as well as magnesium or aluminum alloys can be processed by means of the inventive deforming process.

It is conceivable to employ metal containing composites as rolled profiles of a structure of assembled components as structural and safety components. The advantage of these materials is comprised therein, that they can be employed “mass tailored” for the rolled sections, so that reinforcements are introduced only in the desired rolled section areas.

By the inventive process, high strength steels can be deformed. The deforming of the steels is economically carried out in accordance with the invention in that all process steps can incur in a device with at least one separate processing facility. Thereby, the production time for the components is reduced.

### BRIEF DESCRIPTION OF THE DRAWINGS

In the following, the subject matter of the invention will be described in greater detail on the basis of an illustrative embodiment and FIG. 1.

There is shown:

FIG. 1 a schematic representation of the inventive process.

### DETAILED DESCRIPTION OF THE INVENTION

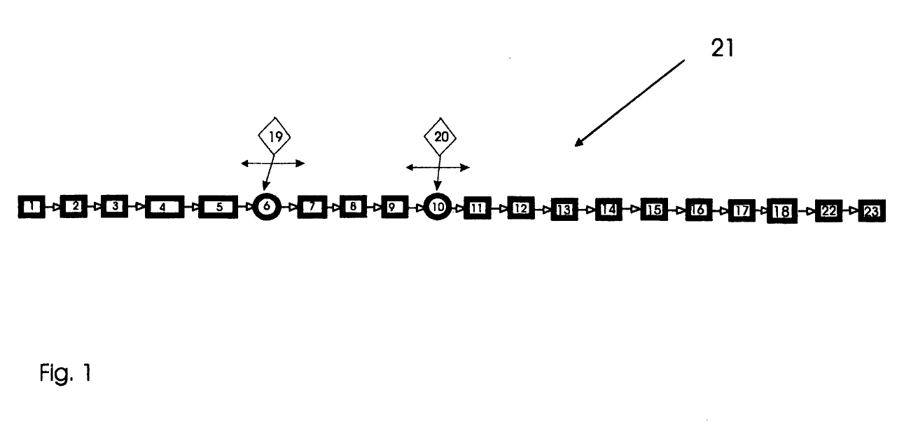

FIG. 1 schematically represents an exemplary embodiment of the inventive process for production of rolled sections from a blank. As starting material for the blank, TRIP 700 (TRIP-steel) is employed in the form of a coil 1. TRIP 700 is characterized by a high rigidity with good ductility and is easily deformed by the inventive process.

In a first process step, the blank is supplied to an interconnected processing facility for straightening or truing 2, thereafter it is cut in a next process step in an interconnected processing facility for cutting 3, is deformed in a spiral storage 4 in another interconnected production facility, after which it is marked in an interconnected processing facility for marking 5. These interconnected processing facilities are rigidly interconnected among each other. Subsequently, the blank is releasably joined by welding 6 with a rolled section in a third processing step, which rolled section was produced in a coordinated production facility for production of components 19 separately provided from the processing facility for deforming 7. Therein, the joint location lies centrally upon the blank in such a manner that the areas laying to the side of the joint location of the blank can be roller profiled in a subsequent step. Therein, the production facility for production of components 19 is located in such a manner to the production facility for deforming 7, that the components therefore are operable continuously. After the first roller profiling step, the rolled section is deep drawn 8, crimped 9, and, subsequent to the production facility for deforming the blank into a rolled profile 11, it is permanently joined by welding in a supplemental rolled profile of the second separate provided production facility for production of components 20 via a mobile production device for joining 10. Therein, the supplemental rolled section is provided on the area of the roller profile rolled section in such a manner that the joining area is beside the inner sidewall. In a subsequent step, the rolled section is again roller profiled in the production facility for deforming the blank into a rolled section 11. After this step, the rolled section is again deep drawn 12 and crimped 13, and subsequently bent in an interconnected production facility for bending 14. In order to ensure the desired length of the rolled section, the rolled section is trimmed or separated in an interconnected processing facility for separating 15 following roller profiling. This production facility for separating 15 is rigidly linked to or interconnected with the other processing facilities. Subsequently, the rolled section has holes imparted to it with close tolerance high precision in an interconnected processing facility for imparting holes 16, in order to achieve a better construction utility. In a subsequent processing step, further components, such as for example screws, nuts, and rivets are releasably joined on the rolled section in an interconnected processing facility for joining 17. Subsequently, the rolled section passes through a production facility for washing 18, a production facility for painting 22, and a production facility for thermal treatment 23 in order to prepare it for a possible subsequent further processing. Therewith, the structure of assembled components is produced, which is precisely adapted to the later intended utility.

1. A device for producing rolled sections (21) including at least:
a production facility for deforming a blank into a rolled section (7,11),
a production facility for joining the blank and/or the rolled section with at least one further component (6,10),
which production facilities are coordinated to each other, and
at least one production facility for production of at least one component (19,20) coordinated with the other production facilities.

2. The device according to claim 1, wherein the production facility for joining (6,10) is mobile.

3. The device Device according to claim 1, wherein the device for production of rolled sections (21) supplementally includes at least one interconnected processing facility for straightening (2) and/or an interconnected processing facility for coating (3) and/or an interconnected production facility for marking (5) and/or an interconnected production facility for deep drawing (8,12) and/or an interconnected production facility for crimping (9,13), and/or an interconnected processing facility for bending (14), and/or an interconnected production facility for separating (15), and/or an interconnected processing facility for imparting holes (16), and/or an interconnected processing facility for washing (18), and/or an interconnected production facility for coating (22), and/or an interconnected production facility for thermal treatment (23), and/or at least one interconnected spiral accumulator for storage (4).

4. The device according to claim 1, wherein the production facility for production of at least one component (19,20) is provided in such a manner relative to the production facility for deforming of the blank into a rolled section (7,11), that the supply of the components can be operated discontinuously.

5. A process for production of rolled sections with the processing steps:
deforming a blank into a rolled section,
joining of the blank and/or the rolled section with at least one other component, wherein
the production of the at least one other component occurs in at least one other production facility (19,20) coordinated in space and in time with the other processing steps.

6. The process according to claim 5, wherein at least one component is joined with at least one blank in a processing facility prior to the processing facility for deforming of the blank into a rolled section (7,11).

7. The process according to claim 5, wherein during the deforming in the device for production of rolled sections (21) and/or immediately subsequent to the production facility for deforming of the blank into a rolled section (11) at least one component, which is produced in at least one separate production facility, is joined with the rolled section to form a structure of assembled composites discontinuously using a production facility for joining (17).

8. The process according to claim 5, wherein in the production device for deforming a blank into a rolled section (7,11) the blank is deformed in two steps separate from each other.

9. The process for production of rolled sections according to claim 5, wherein as a starting material for the blank, high strength steel, and/or deep drawn steel, and/or titanium alloys, and/or nickel alloys, and/or light construction steel, and/or metal containing composite materials are employed.

10. The device according to claim 2, wherein the production facility for joining (6,10) is located prior to the production device for deforming (7,11).
